(19) United States
(12) Patent Application Publication
(10) Pub. No.: US 2008/0298192 A1
(43) Pub. Date: Dec. 4, 2008

(54) Method and System for Adjusting the Pitch of Light Spots Used to Read an Information Carrier

(75) Inventor: Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,984

(22) PCT Filed: Nov. 9, 2006
(86) PCT No.: PCT/IB06/54173

§ 371 Date: May 8, 2008

(30) Foreign Application Priority Data
Nov. 14, 2005 (CN) 200510124719.7

(51) Int. Cl. G11B 20/18

(52) U.S. Cl. 369/53.25; G9B/20.046

(57) ABSTRACT

The invention relates to a method and system for adjusting the pitch of an array of light spots (103) in an information carrier reading apparatus so as to correspond with the size of the macro-cells in which data is stored. A degree of mismatch between the pitch of the array of light spots (103) and the size of the macro-cells is determined when the probe array generation device (102) is illuminated with an input light beam, and the pitch adjusted accordingly by adjusting the distance of the focus of the light source (12) so as to converge or diverge the input light beam (104) to the probe array generation device (102), thereby to create a non-collimated input light beam (104) and magnify the pitch of the array of light spots (103) accordingly.

### FIELD OF THE INVENTION

The invention relates to a method and system for adjusting the pitch of the light spots used to read macro-cell data of an information carrier.

The invention may be used in the field of optical data storage.

### BACKGROUND OF THE INVENTION

The use of optical storage is nowadays widespread for content distribution, for example in storage systems based on the DVD (Digital Versatile Disk) standards. Optical storage has a big advantage over hard-disk and solid-state storage in that information carriers are easy and cheap to duplicate.

However, due to the large amount of moving parts in the drives, known applications using this type of storage are not robust to shocks when performing read operations, considering the required stability of said moving parts during such operations. As a consequence, optical storage cannot easily be used in applications which are subject to shocks, such as in portable devices.

New optical storage solutions have thus been developed. These solutions combine the advantages of optical storage in that a cheap and removable information carrier is used, and the advantages of solid-state storage is that the information carrier is still and that its reading requires a limited number of moving elements.

A system aiming at reading data stored on an information carrier is known. The information carrier is intended to store binary data organized according to an array, as in a data matrix. If the information carrier is intended to be read in transmission, the states of binary data stored on the information carrier are represented by transparent areas and non-transparent areas (i.e. light-absorbing). Alternatively, if the information carrier is intended to be read in reflection, the states of binary data stored on the information carrier are represented by non-reflective areas (i.e. light-absorbing) and reflective areas. The areas are marked in a material such as glass, plastic or a material having magnetic properties.

In basic terms, the known system comprises:
an optical element for generating an array of light spots from an input light beam, said array of light spots being intended to scan said information carrier;
a detector for detecting said data from an array of output light beams generated by said information carrier.

In a first embodiment depicted in FIG. 1, the known system for reading data stored on an information carrier 101 comprises an optical element 102 for generating an array of light spots 103 from an input light beam 104, said array of light spots 103 being intended to scan the information carrier 101.

The optical element 102 corresponds to a two-dimensional array of micro-lenses to the input of which the coherent input light beam 104 is applied. The array of micro-lenses 102 is placed parallel and distant from the information carrier 101 so that light spots are focussed on the information carrier. The numerical aperture and quality of the micro-lenses determines the size of the light spots. For example, a two-dimensional array of micro-lenses 102 having a numerical aperture which equals 0.3 can be used. The input light beam 104 can be realized by a waveguide (not represented) for expanding an input laser beam, or by a two-dimensional array of coupled micro lasers.

The light spots are applied on transparent or non-transparent areas of the information carrier 101. If a light spot is applied on a non-transparent area, no output light beam is generated in response by the information carrier. If a light spot is applied on a transparent area, an output light beam is generated in response by the information carrier, said output light beam being detected by the detector 105. The detector 105 is thus used for detecting the binary value of the data of the area to which the optical spot is applied.

The detector 105 is advantageously made of an array of CMOS or CCD pixels. For example, one pixel of the detector is placed opposite an elementary data area containing one data (i.e. one bit) of the information carrier. In that case, one pixel of the detector is intended to detect one data of the information carrier.

Advantageously, an array of micro-lenses (not represented) is placed between the information carrier 101 and the detector 105 for focusing the output light beams generated by the information carrier on the detector, for improving the detection of the data.

In a second embodiment depicted in FIG. 2, the known system for reading data stored on an information carrier 201 comprises an optical element 202 for generating an array of light spots 203 from an input light beam 204, said array of light spots 203 being intended to scan the information carrier 201.

The optical element 202 corresponds to a two-dimensional array of apertures to the input of which the coherent input light beam 204 is applied. The apertures correspond for example to circular holes having a diameter of 1 μm or much smaller. The input light beam 204 can be realized by a waveguide (not represented) for expanding an input laser beam, or by a two-dimensional array of coupled micro lasers.

The light spots are applied to transparent or non-transparent areas of the information carrier 201. If a light spot is applied to a non-transparent area, no output light beam is generated in response by the information carrier. If a light spot is applied to a transparent area, an output light beam is generated in response by the information carrier, said output light beam being detected by the detector 205. Similarly as the first embodiment depicted in FIG. 1, the detector 205 is thus used for detecting the binary value of the data of the area on which the optical spot is applied.

The detector 205 is advantageously made of an array of CMOS and CCD pixels. For example, one pixel of the detector is placed opposite an elementary data area containing a data of the information carrier. In that case, one pixel of the detector is intended to detect one data of the information carrier.

Advantageously, an array of micro-lenses (not represented) is placed between the information carrier 201 and the detector 205 for focusing the output light beams generated by the information carrier on the detector, improving the detection of the data.

The array of light spots 203 is generated by the array of apertures 202 in exploiting the Talbot effect which is a diffraction phenomenon working as follows. When a coherent light beams, such as the input light beam 204, is applied to an object having a periodic diffractive structure (thus forming light emitters), such as the array of apertures 202, the diffracted lights recombine into identical images of the emitters at a plane located at a predictable distance z0 from the diffracting structure. This distance z0 is known as the Talbot distance. The Talbot distance z0 is given by the relation z0=2 .n.d²/λ, where d is the periodic spacing of the light emitters, λ is the wavelength of the input light beam, and n is the refractive index of the propagation space. More generally, re-imaging takes place at other distances z(m) spaced further from the emitters and which are a multiple of the Talbot distance z such that z(m)=2 .n.m.d²/λ, where m is an integer. Such a re-imaging also takes place for m=/2+an integer, but here the image is shifted over half a period. The re-imaging also takes place for m=¼+an integer, and for m=¾+an integer, but the image has a doubled frequency which means that the period of the light spots is halved with respect to that of the array of apertures.

Exploiting the Talbot effect allows to generate an array of light spots of high quality at a relatively large distance from the array of apertures 202 (a few hundreds of μm, expressed by z(m)), without the need for optical lenses. This allows to insert for example a cover layer between the array of aperture 202 and the information carrier 201 to prevent the latter from contamination (e.g. dust, finger prints . . . ). Moreover, this facilitates the implementation and allows to increase in a cost-effective manner, compared to the use of an array of micro-lenses, the density of light spots which are applied to the information carrier.

FIG. 3 depicts a detailed view of the know system previously described. It depicts a detector 305 which is intended to detect data from output light beams generated by the information carrier 301. The detector comprises pixels referred to as 302-303-304, the number of pixels shown being limited to facilitate the understanding. In particular, pixel 302 is intended to detect data stored on the data area 306 of the information carrier, pixel 303 is intended to detect data stored on the data area 307, and pixel 304 is intended to detect data stored on the data area 308. Each data area (also called macro-cell) comprises a set of elementary data. For example, data area 306 comprises binary data referred to as 306a-306b-306c-306d.

In this embodiment, one pixel of the detector is intended to detect a set of data, each elementary data among this set of data being successively read by a single light spot generated either by the array of micro-lenses 102 depicted in FIG. 1, or by the array of apertures depicted in FIG. 2. This way of reading data on the information carrier is called macro-cell scanning in the following.

FIG. 4 which is based on FIG. 3, illustrates by a non-limitative example the macro-cell scanning of an information carrier 401.

Data stored on the information carrier 401 have two states indicated either by a black area (i.e. non-transparent) or white area (i.e. transparent). For example, a black area corresponds to a “0” binary state while a white area corresponds to a “1” binary state.

When a pixel of the detector 405 is illuminated by an output light beam generated by the information carrier 401, the pixel is represented by a white area. In that case, the pixel delivers an electric output signal (not represented) having a first state. On the contrary, when a pixel of the detector 405 does not receive any output light beam from the information carrier, the pixel is represented by a cross-hatched area. In that case, the pixel delivers an electric output signal (not represented) having a second state.

In this example, each set of data comprises four elementary data, and a single light spot is applied simultaneously to each set of data. The scanning of the information carrier 401 by the light spots 403 is performed for example from left to right, with an incremental lateral displacement which equals the distance between two elementary data.

In position A, all the light spots are applied to non-transparent areas so that all pixels of the detector are in the second state.

In position B, after displacement of the light spots to the right, the light spot to the left is applied to a transparent area so that the corresponding pixel is in the first state, while the two other light spots are applied to non-transparent areas so that the two corresponding pixels of the detector are in the second state.

In position C, after displacement of the light spots to the right, the light spot to the left is applied to a non-transparent area so that the corresponding pixel is in the second state, while the two other light spots are applied to transparent areas so that the two corresponding pixels of the detector are in the first state.

In position D, after displacement of the light spots to the right, the central light spot is applied to a non-transparent area so that the corresponding pixel is in the second state, while the two other light spots are applied to transparent areas so that the two corresponding pixels of the detector are in the first state.

The scanning of the information carrier 401 is complete when the light spots have been applied to all data of a set of data facing a pixel of the detector. It implies a two-dimensional scanning of the information carrier. Elementary data which compose a set of data opposite a pixel of the detector are read successively by a single light spot.

FIG. 5 depicts a three-dimensional view of the system as depicted in FIG. 2. It comprises an array of apertures 502 for generating an array of light spots applied to the information carrier 501. Each light spot is applied and scanned over a two-dimensional set of data of the information carrier 501 (represented by bold squares). In response to this light spot, the information carrier generates (or not, if the light spot is applied to a non-transparent area) an output light beam in response, which is detected by the pixel of the detector 503 opposite the set of data which is scanned. The scanning of the information carrier 501 is performed in displacing the array of apertures 502 along the x and y axes. The array of apertures 502, the information carrier 501 and the detector 503 are stacked in parallel planes. The only moving part is the array of apertures 502.

It is noted that the three-dimensional view of the system as depicted in FIG. 1 would be the same as the one depicted in FIG. 5 in replacing the array of apertures 502 by the array of micro-lenses 102.

The scanning of the information carrier by the array of light spots is done in a plane parallel to the information carrier. A scanning device provides translational movement of the light spots in the two directions x and y for scanning all the surface of the information carrier. Alternatively, the information carrier may be scanned with respect to the array of light spots and the detector (which beneficially comprises a CMOS sensor).

However, thermal expansion and, for example, manufacturing problems in respect of the information carrier can result in a mismatch between the pitch of the array of light spots and the size of the macro-cells, whereas in order to have correct readout of the data bits, the pitch of the array of light spots (or “probe array”) and the size of the macro-cells need to be matched.

### OBJECT AND SUMMARY OF THE INVENTION

It is therefore an object of the invention to provide a system for adjusting the pitch of an array of light spots to correspond with the size of a data area of an information carrier having data stored in the form of an array of data areas

To this end, the system according to the invention comprises:
a light source and an optical device for generating an input light beam;
a probe array generation device for generating said array of light spots from said input light beam intended to be applied to said information carrier so as to generate output beams representative of said data;
a detector for receiving said output light beams and detecting the values of said data;
means for determining a degree of mismatch between the pitch of said array of light spots and the size of the data areas,
means for adjusting the pitch of said array of light spots so as to compensate for said mismatch by adjusting the distance between the focus of said light source and said probe array generation device.

Adjusting the pitch of the probe array to match the size of the macro-cells so as to ensure correct data readout, is achieved by determining a degree of mismatch between the pitch of the probe array and the size of the macro-cells and then adjusting the illumination of the probe array generation device to make a corresponding adjustment to the pitch of the probe array to match the size of the macro-cells. Changing the degree of convergence or divergence of said input light beam allows to generate a non-collimated input light beam.

The invention also relates to a method comprising steps corresponding to various functionalities performed by the various means of the system according to the invention.

These and other aspects of the present invention will be apparent from and elucidated with reference to the embodiments described herein.

### BRIEF DESCRIPTION OF THE DRAWINGS

Embodiments of the present invention will now be described by way of examples only and with reference to the accompanying drawings, in which:

FIG. 1 depicts a first exemplary embodiment of an information carrier reading system;

FIG. 2 depicts a second exemplary embodiment of an information carrier reading system;

FIG. 3 depicts a detailed view of components dedicated to macro-cell scanning used in the systems of FIGS. 1 and 2;

FIG. 4 illustrates the principle of macro-cell scanning;

FIG. 5 depicts a three-dimensional view of the system of FIG. 1;

FIG. 6 depicts an exemplary information carrier for use in a system of the present invention;

FIG. 7 illustrates by a first example the information carrier of FIG. 6;

FIGS. 8 and 9 illustrate schematically a probe generation arrangement in an information carrier reading system according to the prior art, wherein the input beam is a collimated beam;

FIG. 10 illustrates schematically the principle of a method according to an exemplary embodiment of the present invention; and

FIG. 11 illustrates various apparatus and devices comprising a system according to the invention.

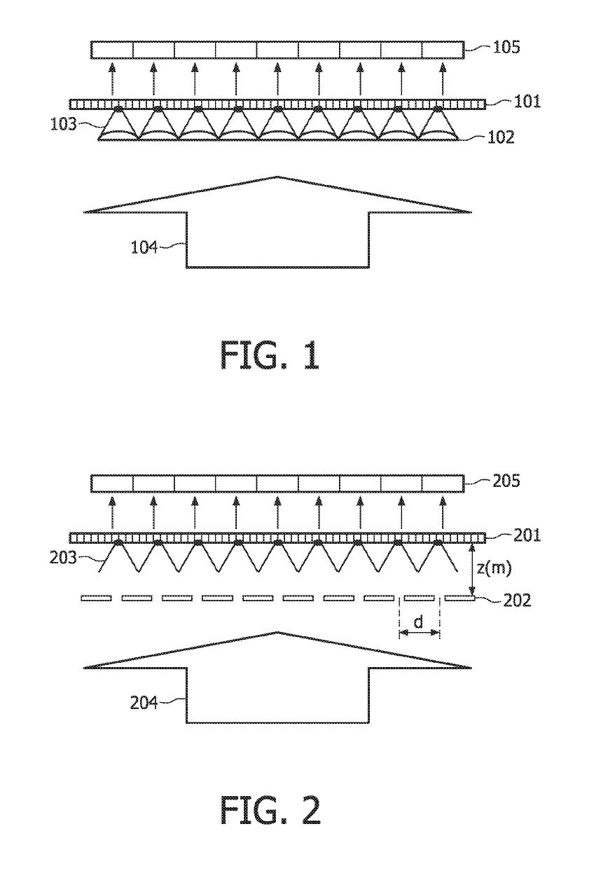

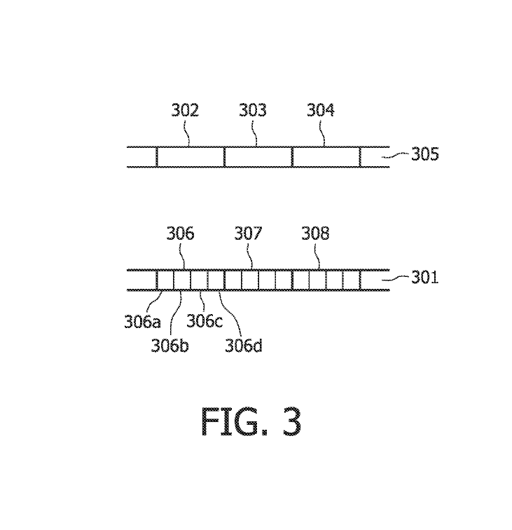

### DETAILED DESCRIPTION OF THE INVENTION

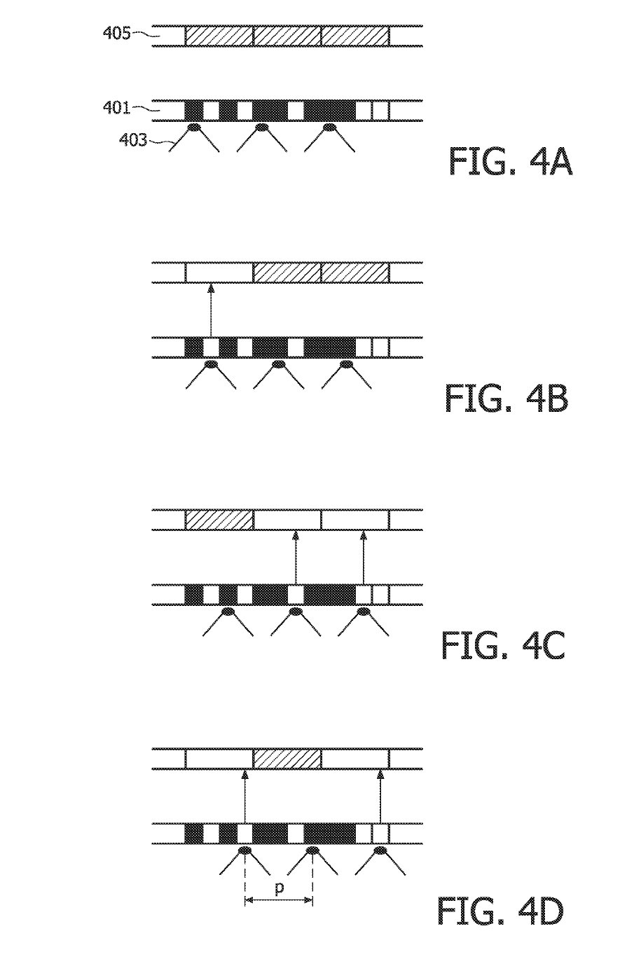

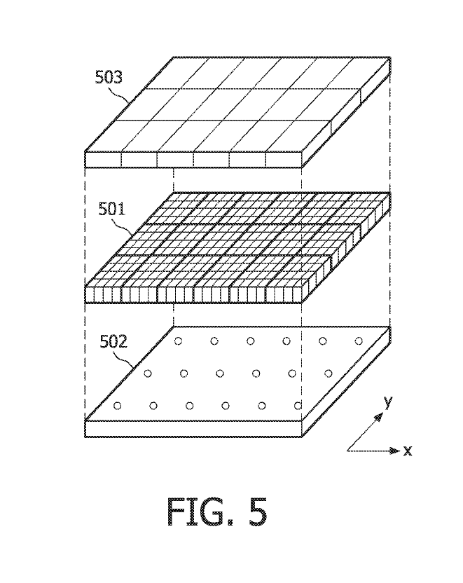

Thus, the present invention provides an arrangement whereby an amount of mismatch (caused, for example, by thermal expansion or manufacturing problems) between the pitch of the probes and the size of the macro-cells can be determined, and the pitch of the probes adjusted accordingly so as to match the pitch p of the probe array and the size of the macro-cells and ensure correct readout of the bits during a macro-cell scanning operation as described above in relation to FIG. 4 of the drawings.

In the following, it will be appreciated that the focus of the light source means the virtual image print and not (necessarily) the light source itself.

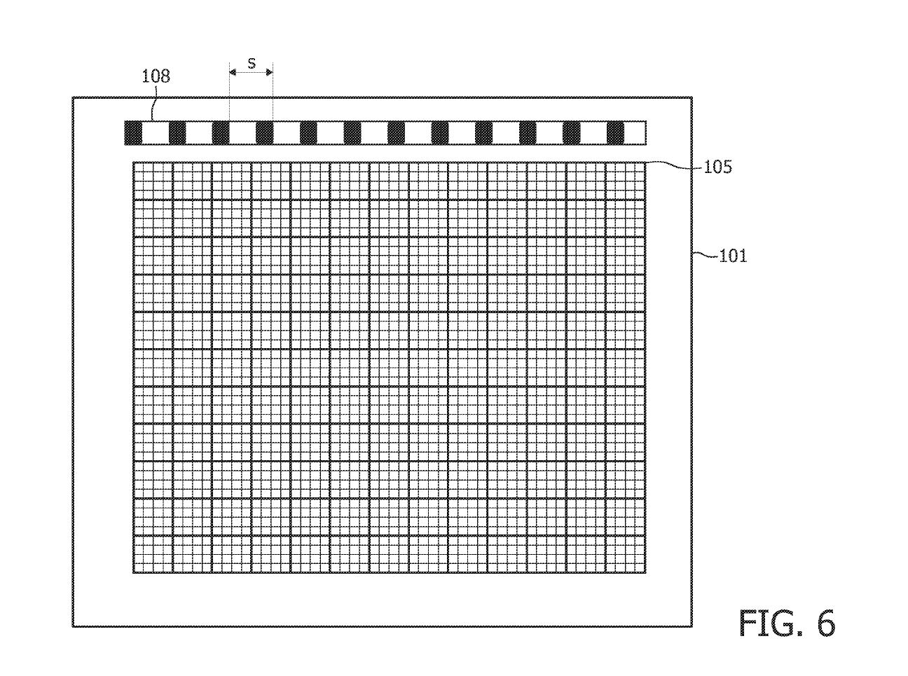

In an exemplary embodiment of the invention, it is proposed to determine the amount of mismatch between the pitch of the probes and the size of the macro-cells by providing on the information carrier (or data card) a periodic structure that is intended to interfere with the probe array so as to generate a Moiré pattern on an area of the detector. The periodic structure 108 may, for example, be printed or glued on the information carrier and may be composed of transparent and non-transparent parallel stripes having a period referred to herein as “s”, as shown in FIG. 6. The data area 105 is made of adjacent macro-cells (squares in bold lines), each macro-cell comprising a set of elementary data areas (sixteen elementary data areas are represented in this example). Each macro-cell is intended to be scanned by one light spot.

The Moiré effect is an optical phenomenon which occurs when an input image with a structure having a period s is sampled with a periodic sampling grid having a period p (i.e. the periodic array of light spots 103 in the present case) which is close or equal to the period s of the input image, which results in aliasing. The sampled image (i.e. the Moiré pattern) is magnified and rotated compared to the input image.

It can be shown that the magnification factor μ of the Moiré pattern, and the angle φ between the Moiré pattern and the period structure are expressed as follows:

$$\begin{matrix}μ = \frac{p}{\sqrt{{p cos θ - s )}^{2} + {( p sin θ )}^{2}}} & ( 1 ) \\ tan φ = \frac{p sin θ}{p cos θ - s} & ( 2 )\end{matrix}$$

where

p is the period of the array of light spots 103,

s is the period of the periodic structure 108,

θ is the angle between the periodic array of light spots 103 and the period structure.

For a situation without angular misalignment between the array of light spots 103 and the periodic structure 108 (i.e. with an angle θ=0), the magnification factor μ0 is expressed as follows:

$$μ 0 = \frac{p}{\vert p - s \vert} \qquad ( 3 )$$

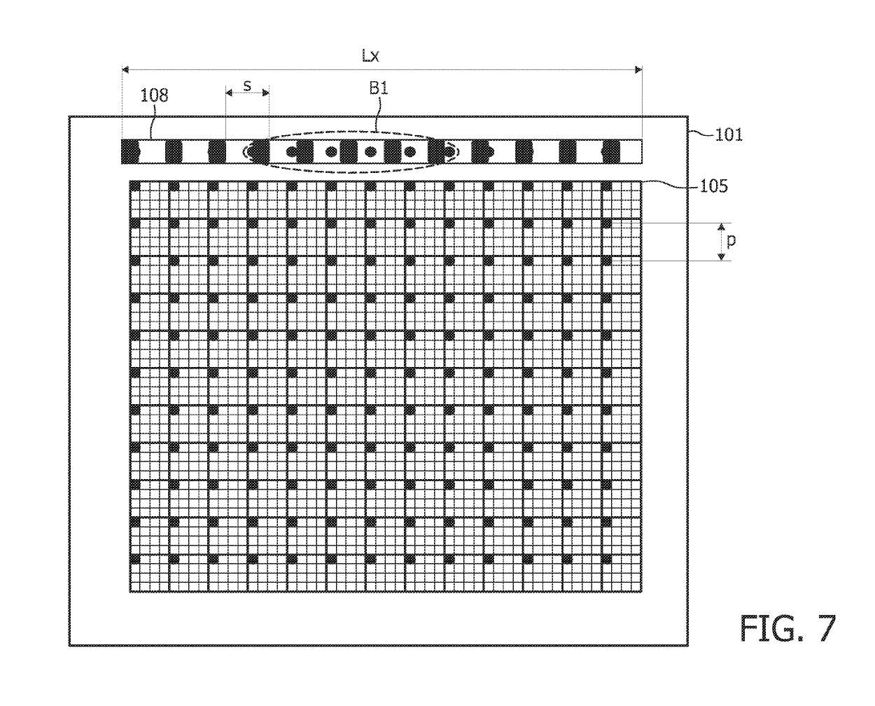

FIG. 7 illustrates the generation of the Moiré patterns. It shows the information carrier 101 on which is applied the array of light spots 103 having a period referred to as “p” in both directions. The light spots are not only applied on each macro-cell of the data area 105, but also on the periodic structure 108. The period p equals the side of the macro-cells. Because of the difference between the period p and the period s of the structure 108, periodic structure 108 is magnified, and detected on the detection area 110.

FIG. 7 represents an initial position of the scanning of the information carrier in which each light spot is to be positioned in the upper left corner of each macro-cell. The periodic structure 108 is magnified, and the corresponding Moiré pattern comprises a light blob B1. The light blob B1 corresponds to the magnification of the transparent stripes located between two adjacent non-transparent stripes of the periodic structure 108.

In the example shown in FIG. 7, only one light blob is generated along the length Lx of the detection area. It can be shown that for having one light blob, the periods s and p have to verify the following relation:

$$\vert p - s \vert = \frac{{p}^{2}}{Lx} \qquad ( 4 )$$

However, by choosing the period (or pitch) of the periodic structure so as to satisfy the relationship:

$$\vert p - s \vert = Cx \frac{{p}^{2}}{Lx} \qquad ( 5 )$$

where c>2 and c<3, two Moiré blocks will be visible on the detector (instead of the single on (B1) shown in FIG. 7). The distance between the blobs is a measure for the pitch of the optical probes and, therefore, mismatch between the pitch of the probe array and the size of the macro-cells on the data card. As such, this distance can be used for controlling the convergence/divergence of the input beam, as will now be described in more detail.

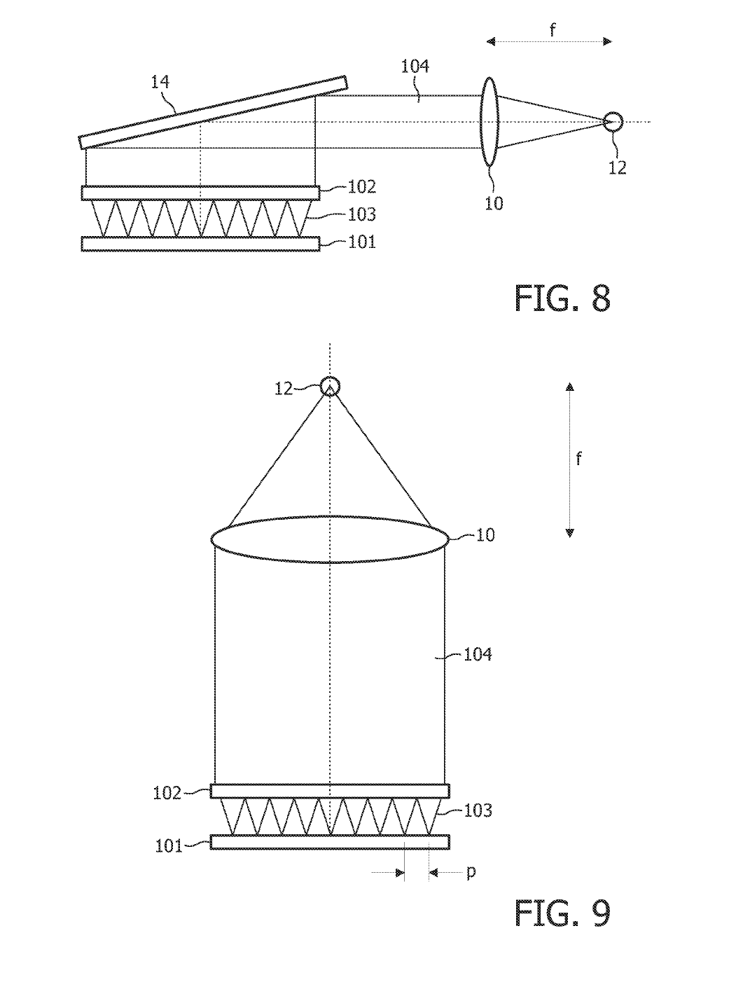

In the known system described above, the probe array generation device is designed to create probes at a certain distance from the device, provided it is illuminated with a collimated beam. Thus, referring to FIG. 8 of the drawings, in a known system, the collimated input light beam 104 is derived from a laser 12 via a collimating lens 10. In a practical system, the collimated beam 104 is directed via a grating 14 onto the probe array generator 102 for generating a probe array comprising an array of light spots 103, and the light spots 103 are applied to the data card 101 for data readout. FIG. 9 illustrates the same system schematically with the grating omitted. The laser 12 is located in the focal plane of the lens 10 (defined by the distance f) such that the resultant input beam 104 applied to the probe array generator 102 is perfectly collimated and the pitch of the probes 103 is p.

Having determined that there is a mismatch between the pitch p of the probe array 103 and the size of the macro-cells on the data card 101, it is proposed herein to match the pitch of the probe array to the pitch of the macro-cells on the data card by adjusting the illumination of the probe array generation device.

In general, a probe array generation device is designed to create probes at a certain distance from the device, provided it is illuminated with a collimated beam. It can be shown that by illuminating the device with a non-collimated beam, the image will be magnified according to

$$M = \frac{v + ɛ z}{v} \qquad ( 6 )$$

where

M is the magnification,

v is the distance from the device to the focus of the illuminating beam,

z is the distance from the device to the spots,

In (6), ε is −1 for a converging beam, and +1 for a diverging beam. Hence the pitch of the probe array changes from p to

M×p (7)

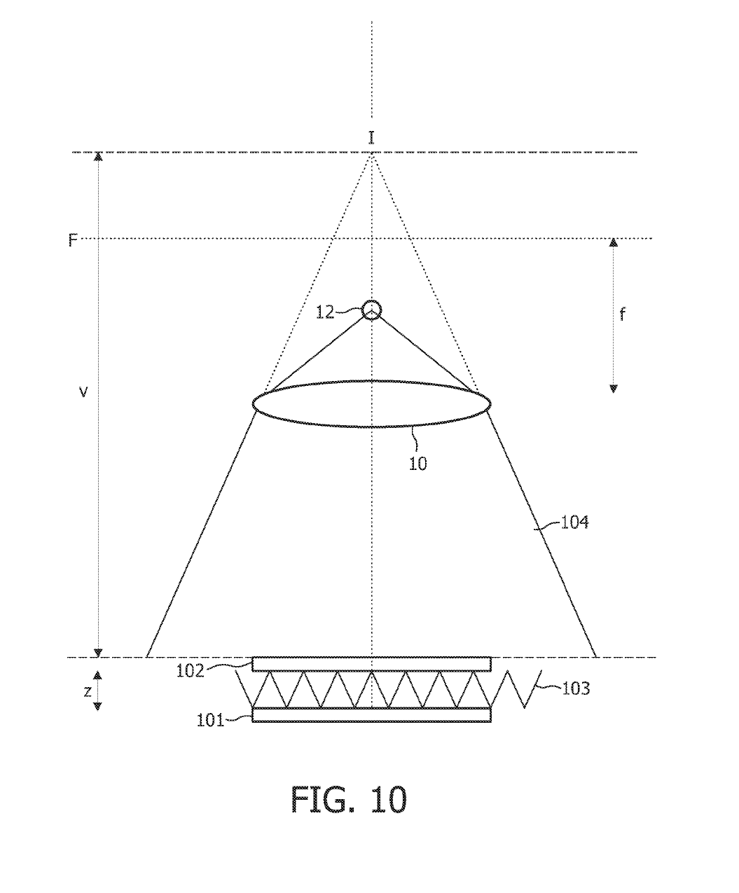

Therefore, by controlling v, the correct pitch of the probe array can be achieved. The illuminating beam can be made converging or diverging using standard optical techniques as for instance actuating the position of a lens in the illumination system along the optical axis;
changing the position of the laser along the optical axis (see FIG. 10)
using an LC cell, which creates the proper phase profile, i.e. a quadratic phase profile (parabola) that acts like a lens;
using an electro-wetting lens.

Thus, in an exemplary embodiment, and referring to FIG. 10, if the laser 12 is shifted out of the focal plane F of the lens 10, a divergent input beam 104 is applied to the probe array generator 102.

The distance from the probe array generator 102 to the virtual source point 1 is defined as v. The distance between the probe array generator 102 and the data card 101 is defined as z. The pitch of the probe array is larger than in the arrangement of FIG. 9 In FIG. 9, the pitch of the probes is defined as p. Due to the divergent illumination beam in the arrangement of FIG. 10, the pitch in FIG. 10, p′ is equal to

$${p}^{′} = p ( 1 + \frac{z}{v} ) \qquad ( 8 )$$

A disadvantage of the non-collimated illumination may be the fact that some spherical aberrations and coma are introduced to the spots. These aberrations are however negligible when the magnification is in the order of 0.1%, which is also the order of magnitude of the thermal expansion of polycarbonate (of which the data card is commonly formed), when the temperature changes by approximately 50 degrees.

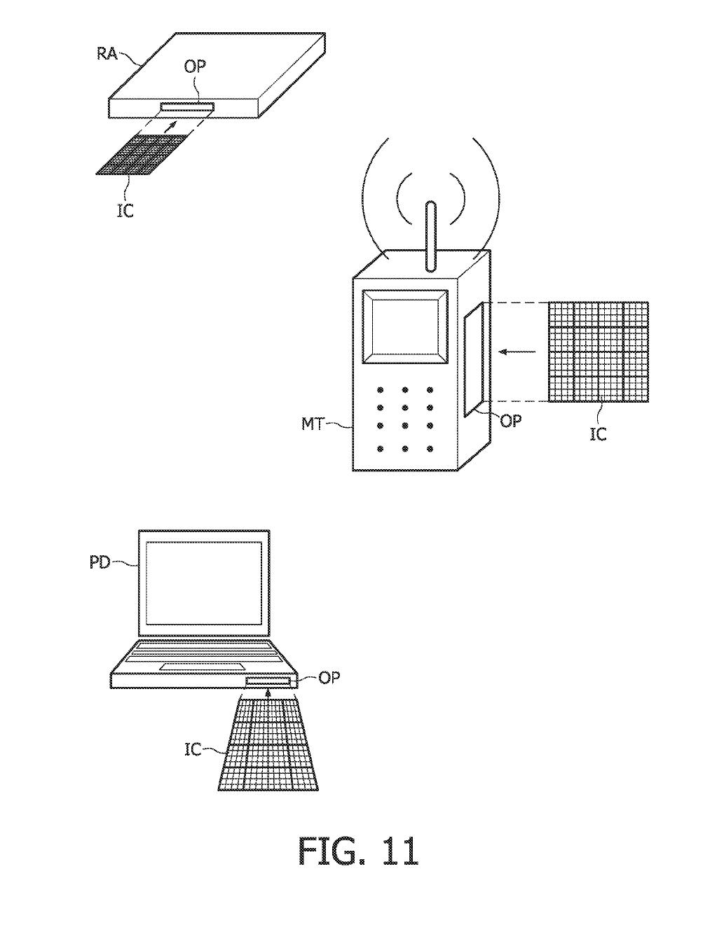

As illustrated in FIG. 11, the system according to the invention may advantageously be implemented in a reading apparatus RA (e.g. home player apparatus . . . ), a portable device PD (e.g. portable digital assistant, portable computer, a game player unit . . . ), or a mobile telephone MT. These apparatus and devices comprise an opening (OP) intended to receive an information carrier IC as previously described, and a system according to the invention for shifting light spots over said information carrier IC in view of data recovering.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system for adjusting the pitch of an array of light spots (103) to correspond with the size of a data area of an information carrier (101) having data stored in the form of an array of data areas, each data area comprising a set of elementary data; said system comprising:
a light source (12) and an optical device (10) for generating an input light beam (104);
a probe array generation device (102) for generating said array of light spots (103) from said input light beam (104) intended to be applied to said information carrier (101) so as to generate output beams representative of said data;
a detector (105) for receiving said output light beams and detecting the values of said data;
means for determining a degree of mismatch between the pitch of said array of light spots (103) and the size of the data areas,
means for adjusting the pitch of said array of light spots (103) so as to compensate for said mismatch by adjusting the distance between the focus of said light source (12) and said probe array generation device (102).

2. A system according to claim 1, wherein said information carrier (101) comprises at least one periodic structure (108) being intended to interfere with said array of light spots (103) for generating a Moiré pattern on an area of said detector (105), the period of which is selected such that said Moiré pattern comprises at least two light patches on said area of said detector (105), wherein the distance between said at least two light patches is used to determine the pitch of said array of light spots (103) and therefore, said degree of mismatch.

3. A system according to claim 1, wherein said pitch of said array of light spots (103) is adjusted by controlling the distance along the optical axis of the light source (12) relative to the focal plane of said optical device (10).

4. A portable device comprising a system as claimed in claim 1.

5. A mobile telephone comprising a system as claimed in claim 1.

6. A game player unit comprising a system as claimed in claim 1.

7. A method for adjusting the pitch of an array of light spots (103) to correspond with the size of a data area of an information carrier (101) having data stored in the form of an array of data areas, each data area comprising a set of elementary data; said method comprising the steps of:
generating an input light beam (104) by a light source and an optical device;
generating said array of light spots (103) from said input light beam (104) intended to be applied to said information carrier (101) so as to generate output beams representative of said data;
detecting the values of said data by receiving said output light beams on a detector;
determining a degree of mismatch between the pitch of said array of light spots (103) and the size of the data areas,
adjusting the pitch of said array of light spots (103) so as to compensate for said mismatch by adjusting the distance between the focus of said light source (12) and said probe array generation device (102).
